(19) United States
(12) Patent Application Publication
(10) Pub. No.: US 2005/0218551 A1
(43) Pub. Date: Oct. 6, 2005

(54) Process for producing polar polyolefines and modified polyolefines thereof

(76) Inventors: Izhar Halahmi, Hod Hasharon (IL); Ziv Herling, Gan Ner (IL); Dror Zur, M.P. Megido (IL); Omari Muhammad, Sandala (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/814,647

(22) Filed: Apr. 1, 2004

(51) Int. Cl. B29C 47/00; C08L 75/00

(52) U.S. Cl. 264/165; 264/211.24; 526/227; 526/319; 526/266; 526/317.1; 524/556

(57) ABSTRACT

A novel process for modification of polyolefines and their copolymers thereof, enables the production of modified PP with minimal deterioration of molecular weight and low gel content PE and their copolymers and with minimal yellowness. The novel compound is comprised of polyolefin resin or a mixture of resins, unsaturated acidic monomer and organic peroxide, together with low volatility polar acrylic co-monomer and low softening point resin, in a continuous reactive reactor The novel process minimizes sublimation of maleic anhydride and improves distribution of monomers and initiator prior to the melting of the polyolefin.

### FIELD OF INVENTION

The present invention generally relates to modified polyolefines. It is also related to a continuous reactive process for producing polar polyolefines at molten phase and modified polyolefines thereof.

### BACKGROUND OF THE INVENTION

Grafting of polar monomers onto polyolefines is a well-known industrial process. The most common process is the grafting of maleic anhydride (hereinafter ‘MA’) onto the backbone chain of a polymer in the presence of organic peroxides. Maleation of polyolefines falls into at least three subgroups: maleation of polyethylene (hereinafter ‘PE’), maleation of polypropylene (hereinafter ‘PP’), and maleation of copolymers of propylene and ethylene or other monomers.

Grafting of polar monomers onto macromolecules in a continuous process in molten phase, unlike grafting in solution, is extensively provided as a reactive extrusion, wherein the reaction is carried out in an extruder, usually a twin-screw type. Maleation of polypropylene in the presence of organic peroxide yields lower molecular weight products with a sharp increase in flow rate due to fragmentation during the maleation process. It is acknowledged in the art that the higher the maleation level, the lower the molecular weight. Another problem, particularly related to such a high level of maleation, is the undesired yellow color characterizing the product.

U.S. Pat. No. 4,548,993 to Garagnani et al. discloses a process for the cross-linking of polymers and copolymers of α-olefins to improve the mechanical resistance characteristics thereof under heating. This process consists of grafting a carboxylic acid onto the polymeric main chains by mechanical mixing of the polymeric product with the acid, at elevated temperature higher than 170° C., and in the subsequent salification of the free carboxylic groups with basic metal compounds.

U.S. Pat. No. 3,932,368 to McConnell et al. presents a powder of carboxylated polyolefin coating composition, prepared by reacting a polyolefin with an unsaturated dicarboxylic acid. One particular process for preparing a maleated polypropylene is to graft maleic anhydride to crystalline polypropylene. Such grafting can be carried out, according to said 368' Pat., by a melt-phase reaction in a compounding extruder or Banbury mixer using a peroxide initiator.

U.S. Pat. No. 6,426,388 to Fujino et al. teaches a modified polyolefin composition obtained by graft polymerizing up to 15.0% of (B) maleic anhydride and up to 7.5% of (C) styrenic monomer to (A) polypropylene, ethylene-propylene copolymer, wherein the propylene content of said ethylene-propylene copolymer is over 85%, or ethylene-propylene-butene copolymer, wherein the propylene content of said ethylene-propylene-butene copolymer is not less than 50%, the grafting weight ratio (B/C) of (B) to (C) being from 2 to 5. The styrene promotes grafting of MA by co-polymerization mechanism, but the drawback of styrene is the unpleasant odor and the high vapor pressure, either at blending stage or in the final product, which present considerable environmental problems. It is further known in the art that styrene is homo-polymerized with MA at temperatures lower than 70° C., thus MA is unavoidably consumed as a side reaction of styrene-MA copolymer at very early stage, instead of being grafted later on.

It is further known in the art that maleic anhydride does not homo-polymerize, neither it does not grafted easily, thus long residence times, high level of peroxide and very intensive mixing is required for high-level maleation. Hence,

U.S. Pat. No. 5,955,547 to Roberts et al., discloses a composition of matter comprising a maleated polypropylene having an acid number greater than 6, a yellowness index color of no greater than 40, a number average molecular weight of at least 20,000, and a Brookfield Thermosel Melt Viscosity of at least about 16,000 cP at 190° C. Another patent to Eastman Chemical Company, namely U.S. Pat. No. 6,046,279 to Roberts et al, introduces a process for the production of maleated polypropylene. The process comprises the three steps of (a) continuously forming a mixture of molten polypropylene and molten maleic anhydride at one end of a screw extruder; (b) continuously introducing a free radical initiator, such as ditertiary butyl peroxide, tertiary butyl hydroperoxide, cumene hydroperoxide, p-menthane peroxide, p-menthane hydroperoxide and 2,5-dimethyl-2,5-bis-(t-butylperoxy)hexane into said mixture to initiate the grafting of the maleic anhydride onto the molten polypropylene to produce a maleated polypropylene; and (c), continuously removing the product from the opposite end of the extruder.

These claimed processes are characterized by several significant industrial drawbacks, namely squandering evaporation of a considerable portion of the MA during its melting, which is a severe environmental problem, difficulties in regulating the pumping of the peroxide at accurate low levels during this continuous process, and complexity of regulating the predetermined molecular weight of the product. The pumping of peroxide creates a local buildup that forms gels in PE and in its copolymers, and irregularities in molecular weight distribution in PP and its copolymers.

It is very important to be able to regulate the grafting of MA onto polyolefines by a co-monomer which is characterized by a low volatility, low toxicity, mild odor, good heat stability and clear homopolymers and copolymers, is reactive with both the MA ingredient and the polymer, and distinguished by a higher polarity as compared with the polymer.

Another problem related to continuous maleation of polyolefines is the sublimation of maleic anhydride during melting prior to reaction. This phenomenon is due to the relatively high melting point of polyolefines and the relatively high vapor pressure of maleic anhydride even at ambient, thus a large percentage of it diffuses back to the feeding inlet, creating environmental problems and blocking the feeding throat. Another problem related to continuous maleation of polyolefines is that most of the peroxide is decomposed in the first half of the extruder, where friction is maximal and heat buildup is most difficult to control. If the amount of it increases, cross-linking of the PE polymers and chain scission of PP polymers ensues.

Yet another problem related to continuous maleation of polyolefines, where all ingredients are pre-mixed instead of simultaneously fed into extruder, arises wherein the difference between bulk densities of the polymer pellets and the maleic anhydride powder generates problems of unstable composition during feeding.

It is thus a long felt need to modify polyolefines by acid anhydride and maleic anhydride specifically and polar co-monomer that have high polarity, low volatility and high reactivity with the MA and the polyolefin, in a process that has minimal sublimation of maleic anhydride from feeding inlet and generates minimal cross-linking in PE polymers and minimal chain scission in PP polymers. It is especially desirable to modify polyolefines by maleic anhydride to a high level of modifications with minimal yellowness and minimal odor and taste in the modified product. A significant advantage will also be obtained if more than one polyolefin may be co-modified and stabilized as a modified-alloy by means of di-, tri- or poly functional co-monomer.

### SUMMARY OF THE INVENTION

The invention is based on the reactive modification of polyolefines at molten phase, with minimal sublimation of maleic anhydride or other volatiles, in the presence of unsaturated acid and esters or anhydride thereof, as well as polar co-monomer that has high polarity, low volatility and high reactivity with polyolefines and unsaturated acid and esters or anhydride thereof in the presence of organic peroxide.

These novel polar polyolefines are produced by a continuous reactive process at molten phase and essentially comprise inter alia the following ingredients: polyolefin resin or a mixture of more than one unsaturated acid or any of its derivatives, ranging from 0 to 5% of formula; free radical initiator comprised of one or more peroxides having T_{1/2} of 1 min. at temperature higher than 135° C., ranging from 0.01 to 1% of formula; unsaturated co-monomer, selected from one or more of the group of mono-, di- or poly acrylate or methacrylate esters of short polyol, polyester or polyurethane, and more polar than the polymer to be modified., or any mixture thereof, ranging from 0.2 to 5% of formula; and, a low softening point resin (tackifier) ranging from 0.5 to 5% of formula. The aforesaid unsaturated acid or any of its derivatives may be selected from one or more of the group of maleic acid, esters and anhydride; acrylic acid, esters and anhydride; methacrylic acid, esters and anhydride or any mixture thereof. The level of the unsaturated acid or any of its derivatives may specifically range from 0.5 to 1.8% of formula. The aforesaid free radical initiator may be comprised of a mixture of two or more organic peroxides that have both T_{1/2} of 1 min at temperature not less than 135° C., and 10° C. to 20° C. degrees difference in T_{1/2} of 1 min between each. The total amount of the peroxide may particularly range from 0.01 to 0.5% of formula.

The aforementioned polar polyolefines may alternatively be comprised of a mixture of first and second organic peroxides. The first peroxide is characterized by a T_{1/2} of 1 min at 180° C. and a the second peroxide is characterized by a T_{1/2} of 1 min at 195° C. This enables utilization of all the extruder length for reaction without buildup of locally-concentrated free radicals in the first half of extruder, thus minimizing gels in ethylene polymers and chain scission in propylene polymers.

It is according to yet another embodiment of the present invention wherein excluding the unsaturated acid or any of its derivatives, the level of the unsaturated acrylate or methacrylate co-monomer ranges from 1.8 to 5% of formula and the level of high acid number acrylate or methacrylated ranges from 0.5-1.5% respectively. The low softening resin (tackifier) may be selected from the group of rosin and rosin derivatives, for example the commercially available PR R-85 Resin by Arizona chemical co.; phenolic tackifier; polyterpene tackifier or any mixture thereof, for example the SYLVARES™ TR 1040 Resin by Arizona chemical Co. The tackifier may alternatively be selected from aromatic C₅ or C₉, for example the commercially available Novares TR-100 Resin by Rutgers Co., low molecular weight polyester and polyamide; wherein the level of the resin is in the range from 0.5 to 5% of formula, and especially 0.75 to 2% of formula.

The polyolefin resin that is to be modified may be selected from at least one of the groups of polypropylene or any copolymer thereof; polyethylene or copolymer thereof, ethylene-propylene-diene monomer elastomer (EPDM) or ethylene-propylene rubber (EPR); ethylen-vinylacetate (EVA); Metallocene catalyzed plastomers (for example ENGAGE by Du-Pont); ethylene-vinyl alcohol (EVOH) or any copolymer thereof. The level of the resin may range from 80 to 99% of formula, and especially from 95 to 99% of formula.

It is in the scope of the present invention to provide a useful coupling agent adapted to couple polyolefines with fillers and fibers. This agent may be comprised of 0.2-1.5% grafted unsaturated acid and 0 to 1% organo-metallic compounds selected from vinyl silane, vinyl containing titanate or zirconate or any mixture thereof.

It is also in the scope of the present invention to provide a useful adhesive or adhesive building-block polyolefin, adapted to adhere plastics to polar substrates selected from wood, paper, metals, polar plastics, glass, ceramics or any mixture thereof.

It is also in the scope of the present invention to provide a useful compatibilizer additive adapted to compatibilize between incompatible thermoplastics and other combinations of non-polar polymers and polar polymers. Incompatible thermoplastics may be selected in a non-limiting manner from EPDM/polyamide, PP/polyamide, PE/polyamide, EPDM/polyester, PP/polyester, PE/polyester or any mixture thereof.

It is also in the scope of the present invention to provide a useful dispersing agent adapted for pigments and nano particles in thermoplastic matrices.

It is also in the scope of the present invention to provide a useful primer for coatings and adhesives when applied onto metals, ceramics, glass, plastic or natural polymers surfaces prior to application of coating or adhesive.

It is also in the scope of the present invention to provide a useful adhesive with improved thermal and environmental stability, adapted to increase the stability compared to standard maleated polyolefines based formulations; comprising 0.0.1 to 2% of the formula of polyamide resin, such as polyamide 6.

The aforesaid olefin is polypropylene or any of its copolymers; wherein the acrylate or methacrylate co-monomer has two or more vinyl groups, such as di-, tri- or tetra-acrylate or methacrylate in most typical applications; so controlled branching and cross linking compensate the chain scission during grafting, an improved dimensional stability and better chemical resistance is obtained.

Accordingly, the acrylate or methacrylate is a blend additionally comprises high acid number acrylate or methacrylate, so that the level of maleic anhydride is reduced by 20-50% so as to have the same overall polarity and decrease the molecular weight less.

It is in the scope of the present invention to provide a useful compatibilized polyolefin alloy, wherein two incompatible olefins are co-modified simultaneously in a reactive extruder; wherein the acrylate monomer missing word two or more vinyl groups, such as di-, tri- or tetra-acrylate in most typical applications, and further wherein monomer level ranges from 0.1 to 1% of formula, such as PE/PP and PE/PP/EPDM alloys. An advantage is higher elongation and toughness combined with a high degree of polarity.

A continuous reactive process for producing polar polyolefines at molten phase in an extruder, comprises inter alia the steps of:

pre-mixing all ingredients so a homogeneous dry, free flowing pellets or powder blend is obtained;

The maleic anhydride dust is immobilized to the polymer pellets or powder by means of the liquid monomers mixture;

Feeding the obtained free flowing mixture (as powder of pellets or flakes or mixture thereof) by standard feeding means into same throat of an extruder, usually a co-rotating twin screw, in such a manner that the first zone of the extruder is heated from 50 to 130° C. so that the tackifier is instantly melted, and the monomers and the peroxides on the polymer pellets or powder are evenly distributed; The molten tackifier seals the gap between screws and barrel, thus minimizing sublimation of MA via the feeding hopper.

The ingredients then react under extensive mixing in the extruder at 160 to 235° C., residence time of 0.5 to 3 minutes, at screw speed 100 to 450 RPM while venting of volatile materials under vacuum occurs in the last section of extruder and the reacted product is collected as a palletized compound.

The aforesaid process may be characterized by a low maleic anhydride sublimation level ranging from 2% to 10%; and by a low gel formation in PE and in any of its copolymers

The aforesaid process enables a high degree of polarity grafted onto PP and its copolymer with minimal degradation of molecular weight; grafting one or more polyolefin simultaneously to form a modified alloy; and/or higher levels of grafting without increasing residence time, which requires a more expensive extruder (up to 73 L/D instead of 40), lower throughput (decrease of 20 to 50%) and increased energy demand. Additionally or alternatively, the process may enable a higher level of polarity with minimal level of maleic anhydride required, due to the polar nature of co-monomer and tackifier; and/or it may enable low odor and low yellowness modified polyolefines, due to the minimal level of maleic anhydride and styrene as co monomer required.

The pre-mixing step may be provided by means selected from ribbon, planetary or paddle mixer and may be batch or continuous. The reactor may be a co-rotating twin-screw extruder or other extruder suitable for extensive mixing of the molten mixture. The feeding step may be comprised of feeding the obtained mixture into the feeding inlet of a continuous reactive reactor; wherein the first section of the extruder is held at a temperature of 50 to 130° C., so as to enable melting of the low melting tackifier, mixing of all monomers and initiator without triggering the reaction, and sealing of the gap between barrel and screws so air is avoided and maleic anhydride can not evaporate back from feeding port.

The reaction of the molten mixture may be provided under extensive mixing at a temperature of 160° C. to 235° C., residence time of 0.5 to 3 minutes, screw speed 100 to 450 RPM, with venting of volatile materials under vacuum at the last section of extruder and collection of the reacted product as palletized compound.

It is still another embodiment of the present invention wherein the continuous reactive process for producing polar polyolefines at molten phase is adapted to produce polar polyolefines comprising: polyolefin resin, unsaturated acid or any of its derivatives ranging from 0 to 5% of formula; free radical initiator comprised of one or more peroxides having T_{1/2} of 1 min. at temperatures higher than 135° C., ranging from 0.01 to 1% of formula, wherein the unsaturated co-monomer is selected from one or more of the group of mono-, di- or poly acrylate or methacrylate esters of short polyol, polyester or polyurethane, or any mixture thereof, ranging from 0.2 to 5% of formula; and a tackifier ranging from 0.5 to 5% of formula.

Lastly, it is another embodiment of the present invention to provide a continuous reactive process for producing polar polyolefines at molten phase in an extruder, comprising inter alia the steps of pre-mixing all ingredients so homogeneous dry, free flowing pellets or powder blend are obtained; immobilizing the maleic anhydride dust to the polymer pellets or powder by means of the liquid monomer; feeding the obtained free flowing mixture by standard feeding means into the extruder, usually a co-rotating twin screw, in such a manner that the first zone of the extruder is heated from 50 to 130° C. so the tackifier is instantly melted, and the monomers and the peroxides on the polymer pellets or powder are evenly distributed and dissolved; and then reacting the ingredients under extensive mixing in the extruder at 160 to 235° C., residence time of 0.5 to 3 minutes, screw speed 100 to 450 RPM while venting volatile materials under vacuum at the last section of extruder and collecting the reacted product as palletized compound; so that polar polyolefines as defined in claim 1 or in any of its dependent claims are produced

### DETAILED DESCRIPTION OF THE INVENTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide polar polyolefines produced by a continuous reactive process at molten phase; comprising a reaction mixture of ingredients selected from polyolefin polymer, unsaturated acid or any of its derivatives; a co-monomer that is a mono-, di- or poly acrylate or methacrylate ester of short aromatic, polyol, polyester or polyurethane, a free radical initiator comprised of one or more peroxides having T_{1/2} of 1 min. at temperature not less than 135° C.; unsaturated monomer; and a low softening temperature resin (namely a tackifier agent).

The term ‘polyolefin resins’ refers hereinafter to any polyolefin resin or to a mixture of more than one polyolefin resin, ranging from 80 to 99% of formula.

The term ‘unsaturated acid’ refers hereinafter to one or more of the group of maleic acid, esters and anhydride; acrylic acid, esters and anhydride; methacrylic acid, esters and anhydride; any of their derivatives or any mixture thereof.

The term ‘tackifier resins’ or ‘tackifier’ refers to a low melt resin with a softening point of 130° C. maximum, and in a specific embodiment of less than 115° C. but higher than 40° C. The tackifier is compatible with the polymer and monomers and does not evaporate during the process; it has excellent thermal stability and does not react with monomers and initiators.

The polymer to be modified is selected from the group of PP or any copolymer thereof; PE or any copolymer thereof; ethylene-propylene-diene monomer elastomer (i.e., EPDM) or ethylene-propylene rubber (EPR) and copolymer thereof, ethylene-vinyl acetate (i.e., EVA) and copolymer thereof, Metallocene catalyzed plastomers, ethylene-vinyl alcohol (i.e., EVOH) and copolymer thereof.

Maleic anhydride is the most favorable unsaturated monomer, due to its tendency to graft onto the polymer rather than to homo-polymerize. Since maleic anhydride is reactive only to a moderate measure, a large percentage of it is lost during reactive extrusion (i.e., sublimation), and hence it may cause severe environmental problems. A co-monomer, styrene for example, can regulate grafting by creation of low molecular weight chains and by increase in initiation points along the chain. The problem with styrene is its unpleasant odor, making high-volume production very problematic, and leaving odor and taste in final product.

A novel regulator monomer can be used instead of styrene, but without the odor and volatily drawbacks: acrylic or methacrylic ester oligomer, and especially those containing short aromatic, polyol, polyester or polyurethane segment, that on the one hand has the grafting advantages of styrene and on the other hand has low volatily and odor. Another advantage of this co-monomer family is the possibility of incorporating di-, tri- or higher functionality (e.g., reactive double-bond containing side groups) thus enabling branching and controlled cross-linking. This new dimension in reactive extrusion enables control of molecular weight in PP to overcome chain scission and to control thermal stability in PE. It also enables stabilization of Inter Penetrating Network (i.e., ‘IPN’) of more than one polymer so as to produce a new family of modified alloy instead of modified polymer. For example, PE and PP can be simultaneously grafted and “co-polymerized” to produce a high strength and stiffness maleated alloy to be used as tie layer adhesive, impact modifier and coupling agent. Another advantage of this novel co-monomer family is the possibility of introducing extra polarity (e.g., via ethoxylated monomers) extra acidity (e.g., via acid containing monomers), extra heat stability (e.g., via aromatic and metal di-acid monomers), secondary cross-linking sites, e.g., via hydroxyl or glycidyl terminated monomers. The level of the co-monomer, denoted hereinafter as the sum of all mono and higher acrylate or methacrylate monomers, is in the range of 0.1 to 5% of formula, most favorably 0.2 to 1.5%. In a specific embodiment, where the level of unsaturated acid and derivatives thereof is zero (i.e., no MA), the level of the co-monomer is 1.8 to 5%, and at least 1% of it is high acid number acrylate or methacrylate oligomer. Such commercially available monomers are produced for example by Sartomer Co.: e.g., SR 9016 metallic diacrylate, CD9050 acid ester mono acrylate.

The free radical initiator is comprised of one peroxide or more, having T½ of 1 min. at temperature not less than 135° C., preferably a mixture of two or more organic peroxides that have both T½ of 1 min. at temperature not less than 135° C., and at least 10° C. degrees difference in T½ of 1 min between each, but not higher than 20° C. degrees. The total amount of peroxide is 0.01 to 0.5% of total formula. A special embodiment is the combination of two peroxides, one having T½ of 1 min at 180° C. and one having T½ of 1 min at 195° C., which enables utilization of all the extruder length for reaction without buildup of local concentration of free radicals in the first half of the extruder, thus minimizing gels in ethylene polymers and chain scission in propylene polymers.

It is according to one embodiment of the preset invention wherein the unsaturated monomer is of the formula of R1;R2;R3(R4,R5); wherein R1 is acrylic or methacrylic group, chemically connected to R2 via an ester group; wherein R2 is a mono, di- or polyether chain, connected to R3 via either ester or ether group, or via wherein R2 is either a short polyester or polyurethane; wherein R3 has a plurality of n acrylate or methacrylate ester side groups, denoted as R4, connected to R3 via an ester group, wherein n is an integer number and n≧0; and further wherein R5 is H, OH, CH₃, glycidyl, acrylate or methacrylate ester, connected to R3 via an ester group.

It is also in the scope of the present invention wherein the novel co-monomer is selected from one or more of the following groups: (i) low vapor pressure monoacrylate and methacrylates; (ii) low vapor pressure, high acid number acrylate and methacrylate; and (iii) di-, tri-, tetra- or penta-acrylate or methacrylate esters. Low vapor pressure monoacrylate and methacrylates may be selected from ethoxylated nonyl phenol acrylate, such as the commercially available products of CD613, CD 614 by Sartomer (USA); low molecular weight nonfunctional acrylate or methacrylate esters, such as the commercially available products CN 131, CN 132, CN152 by Sartomer (USA). Low vapor pressure, high acid number acrylate and methacrylate, may be selected from commercially available products such as the SR 9016 metallic diacrylate, CD9050 acid ester mono acrylate, SR 705 metal diacrylate, or high acid number monoacrylate by Sartomer (USA). These monomers enable introduction of high acidity and thus polarity into polyolefines backbone at low levels of maleic anhydride. Lastly, di-, tri-, tetra- or penta acrylate or methacrylate esters, may be selected from commercially available products such as SR802 diacrylate, SR 259 PEG diacrylate, SR 9008 ethoxylated diacrylate, SR 9035 ethoxylated triacrylate, SR 9051 and 9052 trifunctional acid ester by Sartomer (USA).

### EXAMPLES

### Example 1

MA grafted PP with monoacrylate regulator and acidic tackifier 9700 g of polypropylene by Carmel olefins, such as the commercially available product G-86E PP homopolymer, MFI=3 at 230° C./2.16 kg 130 g maleic anhydride as dry powder, 44 g aromatic monoacrylate, such as the commercially available product CN152 by Sartomer, 8 g of initiator having T_{1/2} of 1 min. at 180, such as the commercially available product Luperox 101 by Elf Atochem, 8 g of initiator having T_{1/2} of 1 min. at 195 (such as Luperox 130 by Elf Atochem), 100 g of low melting tackifier, such as the commercially available product Arizona Silvaros PR R85, were premixed in a ribbon mixer at ambient temperature for 30 minutes and stored in a sealed container.

The mixture was fed dry at ambient temperature into a co-rotating twin-screw extruder with L/D of 40 and screw configuration designed for residence time of 80 sec. at 200 RPM, with vacuum venting port at the last portion of the extruder. The feeding zone was held at 100° C. to melt the tackifier and disperse the initiator and monomers. The reaction was carried out at 220° C. The product has a light yellow color, and very mild odor, Grafted maleic anhydride content as measured by FTIR analysis of dry film of the product of 0.8%, was MFI of 90 at 230° C./2.16 kg. The coupling to glass fibers when this product was incorporated at the level of 2% into PP homopolymer filled with 30% glass fibers was equal to and slightly better then that of standard MA-grafted PP containing composite.

No fumes of maleic anhydride were detected in the feeding port, vent or palletizing head, unlike the control run that did not have the acrylate monomer and the low melting tackifier where severe irritation to people was reported. When nonpolar aromatic tackifier was used, such as the commercially available product Rutgers TR100, similar properties were obtained but with a slightly darker color due to the dark brown color of tackifier. When 0.1% vinysilane, such as the commercially available product Crompton A171 was introduced into the formula, the adhesion to glass fibers was improved by 15% and the durability in a humid environment was improved relatively to standard MA-grafted PP based composite. This silane grafted compound also showed significant improvement in properties of mineral filled PP (alumina tri hydrate, for example).

The MFI of a control batch that contained the same ingredients but did not have the acrylate co-monomer and the low melting tackifier was dark yellow and impossible to detect by standard MFI tester (too high) and the product could not be palletized, since it was waxy. The maleic anhydride escaped from feeding port and caused severe irritation to people in the vicinity, even 10 meters from the extruder. The crystals of maleic anhydride blocked the feeding port and the machine had to be stopped every 30 minutes. The same was reported when only one peroxide was used.

A control batch that contained styrene instead of the acrylate co-monomer had MFI of 80 to 150 at 230° C./2.16 kg, grafted MA content of 0.5 to 1.03 and a strong unpleasant odor. The color was clear and the coupling efficiency very good. Due to the high volatility of styrene it was impossible to use it at large batch volumes, since it evaporated from the dry blend. When styrene was used but no tackifier, the same MA sublimation problems were reported.

### Example 2

MA grafted PP with mono and diacrylate regulators and aromatic tackifier 9700 g of polypropylene (such as the commercially available product Carmel olefins, G-86E PP homopolymer, MFI=3 at 230° C./2.16 kg), 150 g maleic anhydride, 5 to 30 g aliphatic diacrylate such as the commercially available product SR 238 by Sartomer and 40 to 75 g monoacrylate (such as the commercially available product CN152 by Sartomer) 10 g of initiator having T_{1/2} of 1 min. at 180° C. (such as the commercially available product Luperox 101 by Elf Atochem), 10 g of initiator having T_{1/2} of 1 min. at 195° C. (such as the commercially available product Luperox 130 by Elf Atochem), 100 g of low melting tackifier (such as the commercially available product Rutgers TR100), were premixed in ribbon mixer at ambient for 30 minutes and stored in a sealed container.

The mixture was fed into a co-rotating twin-screw extruder with L/D of 40 and screw configuration designed for residence time of 80 sec. at 200 RPM, with vacuum venting port at the last portion of extruder. The feeding zone was held at 100° C. to melt the tackifier and disperse the initiator and monomers. The reaction was carried out at 220° C. The product has a light yellow color, and very mild odor; the maleic anhydride and monoacrylate monomers quantities as well as properties are described in table 1:

TABLE 1

| | Diacrylate | Monoacrylate | MA | MFI |
|---|---|---|---|---|
| | % in original | % in original | % in final | (at 230° C./2.16 kg) |
| Formula | mixture | mixture | product | of final product |
| 2.1 | 0.05 | 0.75 | 0.85-1.05 | 150-100 |
| 2.2 | 0.1 | 0.75 | 0.85-1.05 | 120-80 |
| 2.3 | 0.2 | 0.75 | 0.85-1.05 | 105-75 |
| 2.4 | 0.2 | 0.6 | 0.85-1.05 | 105-75 |
| 2.5 | 0.2 | 0.5 | 0.85-1.05 | 105-75 |
| 2.6 | 0.2 | 0.4 | 0.85-1.05 | 105-75 |
| 2.7 | 0.3 | 0.5 | 0.85-1.05 | 50-80 |
| 2.8 | 0.3 | 0.4 | 0.85-1.05 | 50-80 |

No fumes of maleic anhydride were detected in feeding port or palletizing

### Example 3

MA grafted LLDPE for tie layer adhesives and as coupling agent between PE and mineral fillers and fibers

9700 g of LLDPE, MFI 5 to 17 at 190° C./2.16 kg, 150 g maleic anhydride, 20-150 g aromatic monoacrylate, such as the commercially available product SR 152 by Sartomer, 3 to 5 g of initiator having T_{1/2} of 1 min. at 180° C., such as the commercially available product Luperox 101 by Elf Atochem, 3 to 5 g of initiator having T_{1/2} of 1 min. at 195° C., such as the commercially available product Luperox 130 by Elf Atochem, 50 to 100 g of low melting tackifier, such as the commercially available product Arizona Silvaros PR R85, 0 to 45 g of paraffin oil, 0 to 0.5% vinyl silane such as the commercially available product Crompton A171, were premixed in ribbon mixer at ambient for 30 minutes and stored in a sealed container.

The mixture was fed as dry blend at ambient temperature into a co-rotating twin-screw extruder with LID of 40 and screw configuration designed for residence time of 130 sec. at 300 RPM, with vacuum venting port at the last portion of extruder. The feeding zone was held at 100° C. to melt the tackifier and disperse the initiator and monomers. The reaction was carried out at 200° C. The product has a clear color; and very mild odor, grafted maleic anhydride content (as measured by FTIR analysis of dry film of the product) and flow are described in table 2. One example, in which the acrylate was 0.6% of original formula and the total peroxide was 0.06% of original formula, was compression molded between two sheets of aluminum at 220° C. for 10 sec. The average T-Peel strength was evaluated and found to be 15 PLI. The adhesion remained the same after exposure during 48 hours to hot water (e.g., 80° C. degrees). When 20% EPDM rubber was introduced into formula, the average T-Peel strength was evaluated and found to be 28 PLI. The adhesion remained the same after exposure during 48 hours to hot water (e.g., 80° C. degrees). When this compound was used as the coupling agent between PE and ATH flame retardant (˜60% filler, 3% coupling agent), elongation of 110% was observed. When the same compound was made without coupling agent only 30% elongation was reported.

TABLE 2

| | Monoacrylate | MA | MFI |
|---|---|---|---|
| | % In original | % in final | (at 190° C./2.16 kg) |
| Formula | mixture | product | of final product |
| 3.1 | 0.2 | 0.85-1.22 | 2-6 |
| 3.2 | 0.4 | 0.85-1.22 | 2-6 |
| 3.3 | 0.6 | 0.85-1.22 | 2-6 |
| 3.4 | 0.8 | 0.85-1.22 | 2-6 |
| 3.5 | 1 | 0.85-1.22 | 2-6 |
| 3.6 | 1.2 | 0.85-1.22 | 2-6 |
| 3.7 | 1.4 | 0.85-1.22 | 2-6 |
| 3.8 | 1.5 | 0.85-1.22 | 2-6 |

No fumes of maleic anhydride were detected in feeding port or palletizing unlike the control run that did not have the acrylate monomer ant the low melting tackifier.

The MFI of a control batch that contained same ingredients but did not have the acrylate monomer and the low melting tackifier was MFI of 2 at 190° C./2.16 kg. Fumes of maleic anhydride were detected at feeding port and dark gels were present in the final product, due to poor and uneven dispersion of the initiator prior to mixing with molten LLDPE. The adhesion was only 5 PLI and the repeatability of results was poor. The color was yellow with spots of black gels.

A control batch that contained Styrene instead of the acrylate monomer (0.6% styrene, 0.06% peroxide with and without tackifier) had MFI of 2 to 4 at 190° C./2.16 kg, grafted MA content of 0.9 to 1.1% and a strong unpleasant odor was present. The styrene has good influence on grafting as described in U.S. Pat. No. 6,426,388, since it promotes the grafting of maleic anhydride and trap free anhydride in the form of styrene-maleic anhydride copolymer. The styrene has an unpleasant odor, thus limiting the applications of this product as tie layer adhesive. The control without tackifier had relatively more gels than the embodiment with the tackifier, assumably because the tackifier dissolves and distributes the peroxide and monomers more effectively prior to the melting of the PE.

1. Polar polyolefines produced by a continuous reactive process at molten phase comprising
a. unsaturated acid or any of its derivatives ranging from 0 to 5% of formula;
b. free radical initiator comprised of one or more peroxides having T_{1/2} of 1 min. at temperatures higher than 135° C., ranging from 0.01 to 1% of formula;
c. unsaturated co-monomer selected from one or more of the group of mono-, di- or poly acrylate or methacrylate esters of short polyol, polyester or polyurethane, or any mixture thereof, ranging from 0.2 to 5% of formula; and,
d. low melting resin tackifier, ranging from 0.5 to 5% of formula.

2. The polar polyolefines according to claim 1, wherein the unsaturated acid or any of its derivatives are selected from one or more of the group of maleic acid, esters and anhydride; acrylic acid, esters and anhydride; methacrylic acid, esters and anhydride or any mixture thereof.

3. The polar polyolefines according to claim 1, wherein the level of the unsaturated acid or any of its derivatives ranges from 0.5 to 1.8% of formula.

4. The polar polyolefines according to claim 1, wherein the free radical initiator comprises a mixture of two or more organic peroxides that have both T_{1/2} of 1 min at temperature not less than 135° C., and 10° C. to 20° C. degrees difference in T_{1/2} of 1 min between each.

5. The polar polyolefines according to claim 4, wherein the total amount of the peroxide is in the range of 0.01 to 0.5% of formula.

6. The polar polyolefines according to claim 4, comprising a mixture of a first and a second organic peroxide; the first peroxide is characterized by a T_{1/2} of 1 min at 180° C. and a second peroxide is characterized by a T_{1/2} of 1 min at 195° C.

7. The polar polyolefines according to claim 1, wherein the unsaturated co-monomer is of the formula of R1;R2;R3(R4,R5); wherein R1 is an acrylic or methacrylic group, chemically connected to R2 via an ester group; wherein R2 is a mono, di- or polyether chain, connected to R3 via either ester or ether group, or via wherein R2 is either a short polyester or polyurethane; wherein R3 has a plurality of n acrylate or methacrylate ester side groups, denoted as R4, connected to R3 via an ester group, wherein n is an integer number and n≧0; and further wherein R5 is H, OH, CH₃, high acid number copolymer, glycidyl, acrylate or methacrylate ester, connected to R3 via an ester group.

8. The polar polyolefines according to claim 7, wherein excluding the unsaturated acid or any of its derivatives, the level of the unsaturated co-monomer ranges from 1.8 to 5% of formula; and the level of high acid number acrylate or methacrylated ranges from 0.5 to 1.5% respectively.

9. The polar polyolefines according to claim 7, wherein the sum of all mono and higher acrylate or methacrylate monomers ranges from 0.02 to 5% of formula.

10. The polar polyolefines according to claim 7, wherein the sum of all mono and higher acrylate or methacrylate monomers ranges from 0.03 to 1.5% of formula.

11. The polar polyolefines according to claim 1, wherein the low melting point resin is selected from group of rosin and rosin derivative; phenolic tackifier; polyterpene tackifier, aromatic C₅ or C₉, low molecular weight polyester and polyamide or any mixture thereof; and wherein the level of the resin ranges from 0.5 to 5% of formula.

12. The polar polyolefines according to claim 11, wherein the low melting point resin ranges from 0.75 to 2% of formula.

13. The polyolefin resin according to claim 1, characterized by a modified backbone, selected from at least one of the groups of polypropylene or any copolymer thereof; polyethylene or copolymer thereof ethylene-propylene-diene monomer elastomer (EPDM) or ethylene-propylene rubber (EPR); ethylen-vinylacetate (EVA); Metallocene catalyzed plastomers; ethylene-vinylalcohol (EVOH) or any copolymer thereof.

14. The polyolefin resin according to claim 13, wherein the level of the resin ranges from 80 to 99% of formula,

15. A polyolefin coupling agent according to claim 1, adapted to couple polyolefines with fillers and fibers.

16. The polyolefin coupling agent according to claim 18, comprising 0.01 to 1% organo-metallic compounds selected from vinyl silane, vinyl containing titanate or zirconates or any mixture thereof

17. An adhesive or adhesive building-block polyolefin according to claim 1, adapted to adhere to plastics with polar substrates selected from wood, paper, metals, polar plastics, glass, ceramics or any mixture thereof.

18. An adhesive with improved thermal stability according to claim 1, adapted to increase the thermal stability of maleated polyolefines; comprising 0.01 to 2% in the formula of the polyamide resin.

19. A compatibilizer additive according to claim 1, adapted to compatibilize between incompatible thermoplastics and other combinations of nonpolar polymers and polar polymers.

20. A dispersing agent polyolefin according to claim 1, useful in pigments and nano particles in thermoplastic matrices; comprising 0.01 to 1% organo-metallic compounds selected from vinyl silane, vinyl containing titanate or zirconates or any mixture thereof.

21. A primer according to claim 1, useful for coatings and adhesives when applied onto plastic or natural polymers surfaces prior to application of coating or adhesive.

22. The polyolefin resin according to claim 1, wherein the olefin is polypropylene or any of its copolymer; wherein the acrylate monomer has more than two vinyl groups; so a controlled branching and cross linking compensate the chain scission during grafting, improved dimensional stability, mechanical properties and better chemical resistance are obtained.

23. The polyolefin resin according to claim 7, wherein the acrylate is a blend additionally comprising high acid number acrylate or methacrylated co-monomer, so MA content in the starting formulation is reduced to a level from 0 to 50% of those required in a regular process for a similar acid number, and the MFI is better controlled at a range of 10 to 200 at 230° C./2.16 kg.

24. A compatibilized polyolefin alloy according to claim 1; wherein two incompatible olefins are co-modified simultaneously in a reactive extruder; wherein an acrylate or methacrylate co-monomer that has more than two vinyl groups is included at a level of 0.2 to 2%.

25. A continuous reactive process for producing polar polyolefines at molten phase in an extruder, comprising inter alia the steps of:
a. pre-mixing all ingredients so that homogeneous dry, free flowing pellets or powder blend are obtained and so that the liquid co-monomer immobilizes the maleic anhydride dust to the polymer pellets or a powder;
b. feeding the obtained free flowing mixture by standard feeding means into the extruder, in such a manner that the first zone of extruder is heated from 50 to 130° C. so the tackifier is instantly melted, and the monomers and the peroxides on the polymer pellets or powder are evenly distributed; and then,
c. reacting the ingredients under extensive mixing in the extruder at 160 to 235° C., residence time of 0.5 to 3 minutes, screw speed 100 to 450 RPM while venting volatile materials under vacuum at the last section of extruder and collecting the reacted product as palletized compound.

26. The process according to claim 25, characterized by a low maleic anhydride sublimation level ranging from 1 to 10% of original blend, and grafting yield of 50 to 80% of original blend.

27. The process according to claim 25, characterized by low gel formation in PE and in any of its copolymers, as evident by a smaller number of gel particles per unit length of product, and by a lower level of gel deposit on screws.

28. The process according to claim 25, enabling a high degree of polarity grafted onto PP and its copolymer with minimal degradation of Melt flow rate, of about 0.1 to 0.8 of the MFI of same process without the novel composition.

29. The process according to claim 25, enabling simultaneously compatibilization and grafting of two or more polyolefines to form a modified alloy.

30. The process according to claim 25, enabling higher levels of acid number via the novel acrylate or methacrylate co-monomer that carries acid moieties.

31. The process according to claim 25, enabling a similar level of polarity with 0 to 70% of maleic anhydride required compared to standard maleation process.

32. The process according to claim 25, enabling low odor and low yellowness, wherein yellow index less than 35, modified polyolefines

33. The process according to claim 25, wherein the pre-mixing is provided by means selected from ribbon, planetary or paddle mixer and is batch or continuous.

34. The process according to claim 25, wherein the reactor is a co-rotating twin-screw, counter rotating twin screw, single screw extruder or other extruder suitable for extensive mixing of the molten mixture at with residence time of more than 75 seconds and RPM higher than 200.

35. The process according to claim 25, wherein the feeding step comprises feeding the obtained mixture into the feeding inlet of a continuous reactive reactor; wherein the first section of the extruder is held at temperature of 50 to 130° C. to enable melting of the low melting tackifier, mixing of all monomers and initiator without triggering the reaction, and the molten tackifier also seals the gap between barrel and screws so air is avoided and maleic anhydride can not evaporate back from feeding port.

36. The process according to claim 25, wherein the reaction of the molten mixture is carried under extensive mixing at temperature of 160° C. to 235° C., residence time of 0.5 to 3 minutes, screw speed 100 to 450 RPM, with venting of volatile materials under vacuum at the last section of extruder and collection the reacted product as palletized compound.

37. The continuous reactive process for producing polar polyolefines at molten phase as defined in claim 25 or in any of its dependent claims, adapted to produce polar polyolefines comprising: unsaturated acid or any of its derivatives ranging from 0 to 5% of formula; free radical initiator comprised of one or more peroxide having T_{1/2} of 1 min. at temperature higher than 135° C., ranging from 0.01 to 1% of formula; unsaturated co-monomer selected from one or more of the group of mono-, di- or poly acrylate or methacrylate esters of short polyol, polyester or polyurethane, or any mixture thereof, ranging from 0.2 to 5% of formula; Polyolefin resin or mixture of more than one polyolefin resin, ranging from 80 to 99% of formula, and a tackifier ranging from 0.5 to 5% of formula.

38. A continuous reactive process for producing polar polyolefines at molten phase in an extruder, comprising inter alia the steps of pre-mixing all ingredients so homogeneous dry, free flowing pellets or powder blend are obtained; immobilizing the maleic anhydride dust to the polymer pellets or powder by means of the liquid monomer; feeding the obtained free flowing mixture by standard feeding means into the extruder (usually co-rotating twin screw), in such a manner that the first zone of the extruder is heated from 50 to 130° C. so the tackifier is instantly melted, and the monomers and the peroxides on the polymer pellets or powder are evenly distributed; and then reacting the ingredients under extensive mixing in the extruder at 160 to 235° C., residence time of 0.5 to 3 minutes, screw speed 100 to 450 RPM while venting volatile materials under vacuum at the last section of extruder and collecting the reacted product as palletized compound; so that polar polyolefines as defined in claim 1 or in any of its dependent claims are produced.
